(19) United States
(12) Patent Application Publication
(10) Pub. No.: US 2013/0294200 A1
(43) Pub. Date: Nov. 7, 2013

(54) SIGNAL PROCESSING

(71) Applicants: Tobias Dahl, Oslo (NO); Tom Oystein Kavli, Nittedal (NO)

(72) Inventors: Tobias Dahl, Oslo (NO); Tom Oystein Kavli, Nittedal (NO)

(73) Assignee: ELLIPTIC LABORATORIES AS, Oslo (NO)

(21) Appl. No.: 13/994,994

(22) PCT Filed: Dec. 16, 2011
(86) PCT No.: PCT/GB11/52507

§ 371 Date: Jul. 15, 2013

(30) Foreign Application Priority Data
Dec. 17, 2010 (GB) 1021477.3

(51) Int. Cl. G01S 15/02

(52) U.S. Cl. CPC G01S 15/02
USPC 367/135

(57) ABSTRACT

The disclosed electronic apparatus comprises:
transmitting means 54 arranged to transmit an ultrasonic signal;
receiving means 55 arranged to receive a reflection of the ultrasonic signal from an input object, and to generate a received analogue electrical signal therefrom;
a filter 56 arranged to take the received analogue electrical signal as input and to output a filtered analogue electrical signal; and
digital processing means 52 configured to control a characteristic of the filter 56, and to use the filtered analogue electrical signal to determine a user input to the electronic apparatus.

This invention relates to methods and apparatus for processing an ultrasonic signal to determine a user input.

WO 2009/147398 describes a system for using ultrasound reflections to track a user's finger in space. Such a system can be implemented on an electronic device, such as a personal computer or mobile telephone, in order to allow the device to receive user input, such as cursor control commands, based on the position or motion of the user's finger.

Known systems for receiving a user input based on ultrasound echoes typically receive sounds at one or more microphones, then sample the received sounds using one or more analogue-to-digital (AD) converters. The digital output of these converters is then processed in order to identify and characterise reflections of interest, and so to determine a user input to a device.

The Applicant has come to realise that such an approach has significant shortcomings. In particular, important information in the received acoustic signals can be lost in the analogue-to-digital conversion and subsequent processing, which can lead to inaccurate identification and characterisation of reflections, potentially resulting in the misrecognition of user inputs.

The present invention seeks to overcome such shortcomings of known user input systems.

From one aspect, the invention provides electronic apparatus comprising:
transmitting means arranged to transmit an ultrasonic signal;
receiving means arranged to receive a reflection of the ultrasonic signal from an input object, and to generate a received analogue electrical signal therefrom;
a filter arranged to take the received analogue electrical signal as input and to output a filtered analogue electrical signal; and
digital processing means configured to control a characteristic of the filter, and to use the filtered analogue electrical signal to determine a user input to the electronic apparatus.

The apparatus is preferably a device, such as a mobile telephone, which may be portable.

The invention extends to a method of determining a user input to an electronic apparatus comprising:
transmitting an ultrasonic signal;
receiving a reflection of the ultrasonic signal from an input object;
generating a received analogue electrical signal from the reflection;
filtering the received analogue electrical signal in a filter which outputs a filtered analogue electrical signal; and
controlling a characteristic of the filter with a digital processing means; and
using the digital processing means to determine a user input to the electronic apparatus from the filtered analogue electrical signal.

Thus it will be seen by those skilled in the art that, in accordance with the invention, the received signal is not immediately passed to an analogue-to-digital (AD) converter, but instead passes through a configurable filter, under the control of digital processing means, which outputs an analogue signal. This signal may then subsequently be digitised for further processing by the digital processing means.

In this way, the digital processing means can control an initial processing of the received signal in the analogue domain, before information is removed through digital sampling. As explained in more detail below, by carefully controlling a suitably-chosen filter, the processing means can arrange to send a filtered electrical signal to an AD converter in such a way that the efficiency and/or accuracy of the subsequent processing of the digitised signal to determine a user input can be improved.

It is known, e.g. from U.S. Pat. No. 6,313,825, to pass a received, analogue ultrasound signal through a simple, fixed, low-pass filter, prior to digital conversion. However, such a filter is not under the control of a digital processor, and is therefore of limited use in addressing the shortcomings identified above. The Applicant believes that the provision of a filter having a characteristic controlled by digital processing means, as described above, is novel and advantageous.

The filter is not limited to any particular type, and may comprise a low-pass filter, a high-pass filter, a band-pass filter, a band-stop filter, an all-pass filter, a linear filter, a non-linear filter, a passive filter, an active filter, an infinite impulse response filter, a finite impulse response filter, a pulse compression filter, a multiplicative mixer for frequency conversion, an additive mixed filter, etc. It may comprise a plurality of sub-filters.

The filter takes an analogue input and produces an analogue output. Although the filter might typically contain only analogue components, it may comprise one or more digital components. For example, the filter might comprise an AD converter and a DA converter, with digital logic in between.

The processing means may, for example, determine how to control the filter based on an analysis of signals the processing means is currently receiving, or has previously received.

In one set of embodiments, the characteristic of the filter controlled by the processing means is simply whether the filter is enabled or not. I.e. the processing means is able to turn the filter on (filtering signals) or off (passing signals substantially unchanged) as required. This can improve the accuracy of the system by, for example, enabling the device to filter out interference if it is detected, but still allowing a wider spectrum of received signals to be sampled if such interference is not present. This can be advantageous over using a permanent filter in situations where some of the desired signal is necessarily removed in the filtering process: only when interference is present is the desired signal affected.

In some electronic devices, the receiving means (e.g. a microphone) will be sensitive both to audible sound (such as human voices) and to ultrasound. The same receiving means may be used by the electronic device when receiving and processing audible sounds, such as when making a telephone call, and when determining a user input from an ultrasonic reflection. The filter may filter out audible sounds, so as to improve user input performance. However, it could be deactivated by the processing means when the device needed to process audible sound (such as during a telephone call). Alternatively, the filter might filter out ultrasound, so as to improve audible processing by removing high-frequency noise which could create artefacts in the AD converter. In this case, the filter can be activated when the device needs to process audible sound.

More typically, however, it is envisaged that the processing means will have greater control over a filter than simply turning it on or off. For example, the filter may have two or more modes of operation, with the processing means able to select one or more of these modes.

In one such set of embodiments, the filter selectively either passes audible sound while removing ultrasound, or passes ultrasound while removing audible sound. (The boundary between audible sound and ultrasound is approximately 20 kHz.) The processing means can switch the filter between these two modes depending on whether the device is attempting to receive audible input or ultrasonic input. The switching may be prompted by an input from the user, such as initiating a telephone call or a voice memo record function.

By having such a filter, product costs can be reduced by using the same components, such as a microphone and amplifier, for audible and ultrasonic signal reception, without compromising on the accuracy of the signal processing.

More generally, the Applicant has realised that, by removing unwanted signal components from the received analogue signal before digitisation, the burden on the processing means to separate wanted from unwanted components of the digitised signal is significantly reduced. In this way, less processing power and energy consumption are required when processing received signals, and higher-accuracy results are possible.

The Applicant has also appreciated that, in the prior art, the presence of unwanted signal components can lead to sampling errors in an AD converter, which can be very difficult, if not impossible, to correct for when processing the digitised output. For example, delta-sigma converters commonly used in the prior art suffer from high-pass noise, meaning that ultrasonic signals received by a device's microphone can cause artefacts in a digitised signal being used, say, in a telephone call.

Embodiments of the present invention, by contrast, enable the finite sampling capacity of the AD converter to be targeted at the signal components of interest, by filtering out unwanted components before the signal reaches the AD converter. In this way, the sampling rate and/or resolution of the AD converter can be lower than would be required in the prior art, for the same performance, thereby saving production costs and/or power consumption.

In particular, by controlling the filter appropriately, embodiments of the present invention can reduce the likelihood of the AD converter reaching a numerical overflow condition. When saturated, the output from the AD converter will no longer reflect a linear superposition of received frequencies, resulting in errors in subsequent processing steps, which assume such linear conditions.

The filter may be arranged to band-pass filter or band-stop filter selectively from a plurality of different frequency bands. The characteristic of the filter controlled by the processing means may then comprise which frequency band or bands are to be filtered or passed. The bands may be disjoint or overlapping. Preferably they together span a continuous frequency range, which may be open-ended at the upper and/or lower end. The filter may be arranged to pass or block from a plurality of different ultrasonic ranges.

In such arrangements if the presence of a source of ultrasonic noise, such as another similar device, or a fluorescent light tube, etc. is detected, the processing means can control the filter so as to block a minimum set of bands necessary to suppress the noise, thereby having minimal impact on the remainder of the signal.

A multi-band filter can be controlled by the processing means so as to remove signals outside a band encompassing the reflected signals from the input object, when receiving a user input. The processing means may control the filter using characteristics of the transmit signal and/or analysing the received signals. The processing means may need to change the selection of bands to cope with Doppler shift effects, etc.

By limiting the signal entering the AD converter to a relatively narrow spectrum containing the reflections of interest, a subsequent deconvolution operation can be performed faster. Sub-band fast Fourier transform, or fast under-sampling techniques can be used. Also, the AD converter can be operated at a relatively lower speed. Aliasing can be used constructively, enabling low cost circuitry to be used. Also faster and/or simpler subsequent digital processing, such as de-chirping and other filtering, may be possible.

The filter may comprise a variable bandpass filter, with the digital processing means being configured to control the variable filter so as to output a succession of analogue electrical signals that have been filtered using different respective bandpass ranges.

However, additionally or alternatively, the filter may comprise a plurality of bandpass filters collectively arranged to output a plurality of analogue electrical signals simultaneously.

The filter may be arranged to provide phase information relating to the filtered analogue electrical signal. For example, the filter may comprise a plurality of sine and/or cosine sub-filters. In one set of embodiments, the filter comprises a sine filter and a cosine filter for each of a plurality of frequency ranges. Thus, both amplitude and phase information can be determined for the input signal at each frequency range.

Where the filter comprises a plurality of sub-filters, these may be selectively couplable to an AD converter, e.g. under the control of the processing means, or the device may comprise a plurality of AD converters, with each sub-filter being coupled to a corresponding AD converter.

In one set of embodiments, the transmit signal comprises a chirp (a rising or falling tone). This would traditionally require a corresponding de-chirp (pulse compression) operation to be performed on the digitised received signal before reflections from the input object can be identified. However, by providing a filter comprising a plurality of sub-filters of different (possibly overlapping) frequency ranges, a suitable device embodying the invention can perform a partial de-chirp operation in the analogue domain. A received signal can be decomposed into several (potentially overlapping) frequency bins. These bins may be relatively-narrowband. The outputs of these filters can be digitised and combined, e.g. by appropriate delaying and summing, such that the signal is effectively de-chirped. I.e. a chirp will pass substantially through the filter bank, and be reinforced through the combining operation, while other signals (e.g. line noise) may only pass through the filters to a limited extent, and will be scattered in the delay-and-sum operation. Such an approach to de-chirping can be more computationally efficient than digitising the full spectral width of the received signal and applying a purely digital de-chirp function. Noise may also be reduced. The processing means may control the filter so as to synchronise the routing of the outputs from the appropriate sub-filters to one or more AD converters in order to perform the desired de-chirp operation.

The processing means may be configured to cause the device to transmit different chirps depending on circumstances, and it is then preferably configured to control the filter so as to apply a de-chirp operation for a previously-transmitted chirp signal. Similar, if the processing means is configured to cause the device to transmit another signal (e.g. a train of different frequencies), the processing means may then be configured to control the filter to apply a suitable inverse operation.

Using an analogue filter to perform pulse compression in a touchless interaction system is believed to be novel and inventive in its own right and thus when viewed from another aspect the invention provides electronic apparatus comprising:
transmitting means arranged to transmit an encoded ultrasonic signal;
receiving means arranged to receive a reflection of the ultrasonic signal from an input object, and to generate a received analogue electrical signal therefrom;
a filter arranged to take the received analogue electrical signal as input and to output a filtered analogue electrical signal, wherein said filter is adapted so as at least partially to apply pulse-compression to said analogue electrical signal; and
digital processing means configured to use the filtered analogue electrical signal to determine a user input to the electronic apparatus.

The transmitted ultrasonic signal could, for example, be encoded using a chirp which could be rising or falling.

In some embodiments, the filter is arranged to remove from the received signal a contribution arising from energy in the transmit signal that has travelled along a direct path from the transmitting means to the receiving means (i.e. without being reflected). Such a direct-path signal may have comparable or greater energy than the echo from the input object, and can require complex digital processing to remove in prior-art approaches. By contrast, the Applicant has realised that, if the direct-path contribution can be removed in the analogue domain, then digital processing needs can be reduced as the direct-path contribution does not need to be identified and subtracted in the digital domain, and the potential for AD converter overflow can be lessened. As a consequence, a lower-cost AD converter can be used, supporting a lower number of bits. Additionally, less dynamic range and therefore a lower number of bits are needed for processing the stored received signal in the internal processor. Both of these consequences can lead to reduced overall system costs.

In a set of embodiments the digital processing means is configured to provide to the filter an estimate of the contribution to the received signal arising from signals which travel along the direct path. The filter is then preferably arranged to use this estimate when filtering the received signal. In one set of embodiments, the device sign-reverses the estimate, then passes it through a DA converter, and superimposes (additively mixes) the reversed, analogue estimate on the received analogue signal. In this way, the contribution from the direct-path can be lessened or removed. The mixed signal can then be digitised and processed to determine a user input.

The device preferably comprises feedback means configured to refine the estimate of the direct-path contribution and/or to synchronise the superimposing operation so as to provide effective subtraction. The feedback means may take analogue or digital signals as input.

Using an analogue filter to perform background subtraction in a touchless interaction system is believed to be novel and inventive in its own right and thus when viewed from another aspect the invention provides electronic apparatus comprising:
transmitting means arranged to transmit an ultrasonic signal;
receiving means which receives: i) a direct path signal from the transmitting means; and ii) a reflection of the ultrasonic signal from an input object, and to generate a received analogue electrical signal therefrom;
a filter arranged to take the received analogue electrical signal as input and to output a filtered analogue electrical signal, wherein said filter is adapted to reduce a contribution of the direct path signal in the analogue electrical signal relative to a contribution of the reflected signal; and
digital processing means configured to use the filtered analogue electrical signal to determine a user input to the electronic apparatus.

The transmitting means preferably comprises one or more transmitters, such as speakers capable of generating ultrasound. The receiving means preferably comprises one or more receivers, such as microphones capable of receiving ultrasound. The digital processing means may comprise logic within the device, although it may also or instead comprise a remote server.

The receiving means and the filter may be integrated, e.g. in a single microphone unit, or may be separate.

The processing of the output of an AD converter (which may be filtered versions of the raw signal, or impulse responses, as explained above), in order to determine a user input, can be carried out in any suitable manner known in the art; for example, in accordance with the teachings of WO 2009/147398 and WO 2009/115799.

Optional features of any aspect of the invention may be used with any other aspect as appropriate.

Certain preferred embodiments of the invention will now be described, by way of example only, with reference to the accompanying drawings, in which:

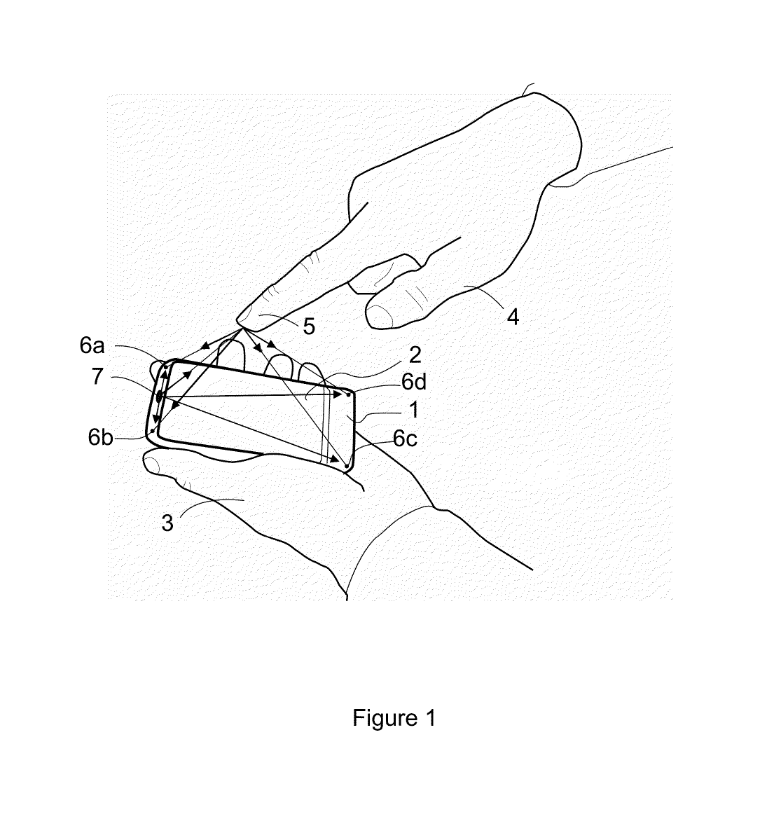

FIG. 1 is a perspective drawing of a user interacting with a handheld device;

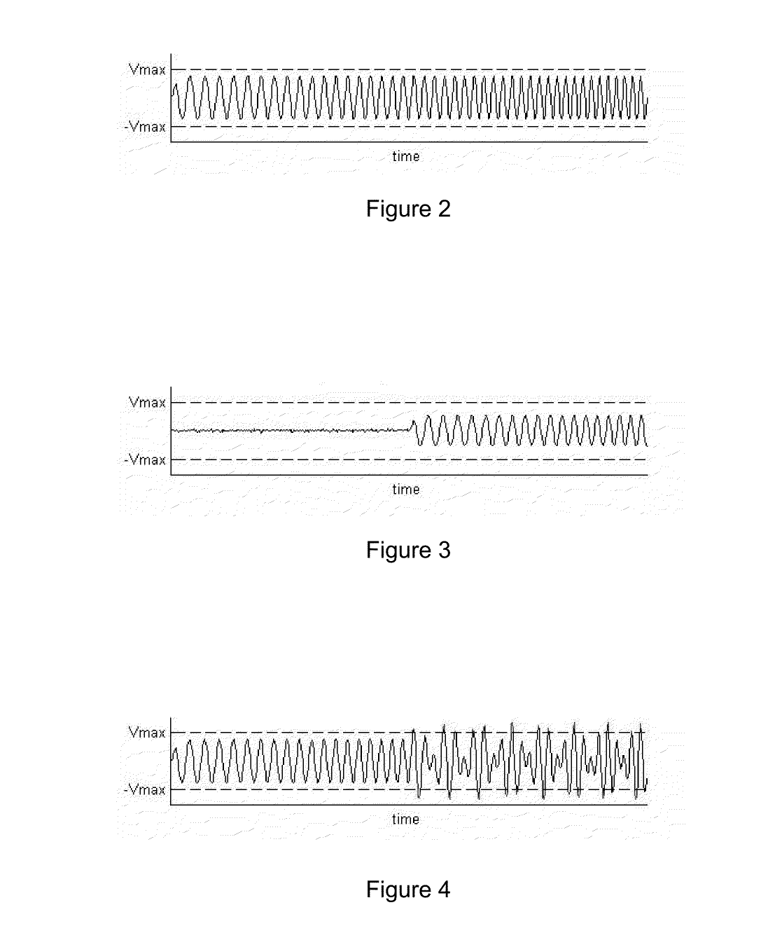

FIG. 2 is a graph of a direct-path received signal;

FIG. 3 is a graph of a reflected received signal;

FIG. 4 is a graph of a superposition of the direct-path and reflected signals;

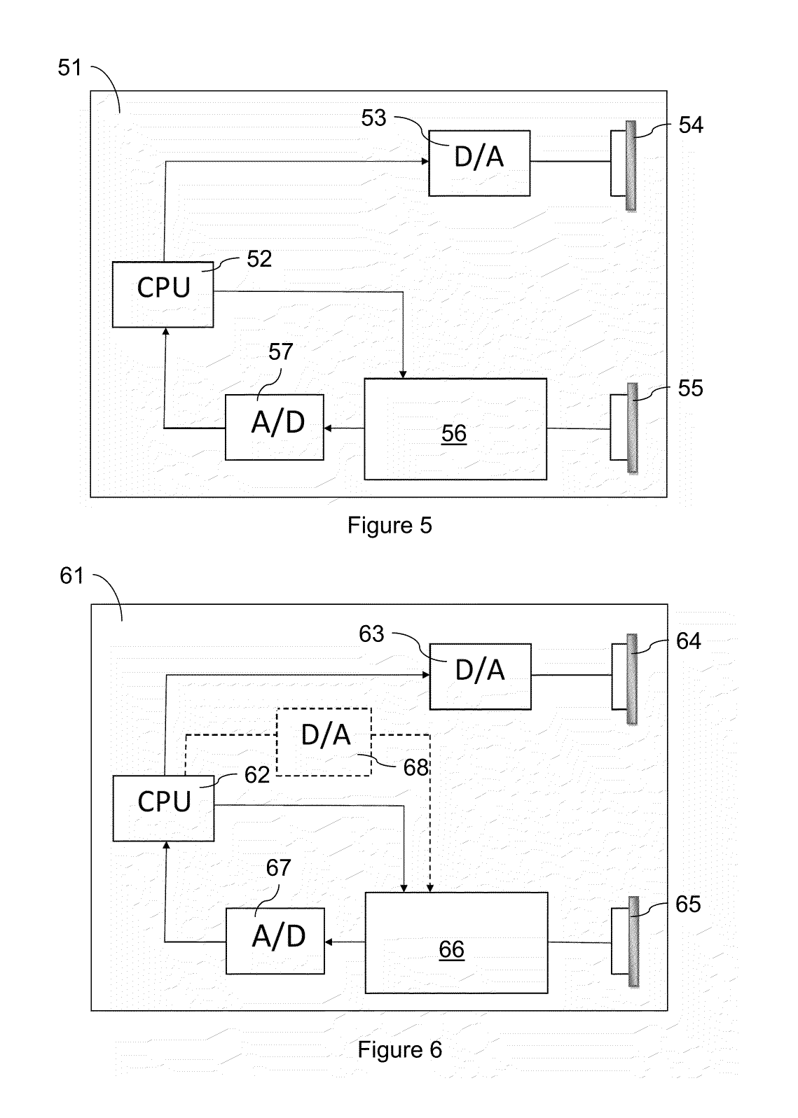

FIG. 5 is a schematic drawing of a device embodying the invention; and

FIG. 6 is a schematic drawing of a modified device embodying the invention.

FIG. 1 shows a handheld device 1 having a substantially rectangular LCD or OLED screen 2 on a front face of the device. Internally, the device contains processing and communications hardware and software which controls the functioning of the device, including interaction with a user. In this illustration, a user is holding the device 1 in his left hand 3, and is using his right hand 4 to provide a command to the device, by moving an extended index finger 5.

Mounted flush with, or recessed into, the front surface of the device 1 are four ultrasonic receivers 6a-6d located around the screen 2 in the respective corners of the face of the device. An ultrasonic transmitter 7 is located centrally adjacent the top edge of the display screen 2. The transmitter 7 and receivers 6a-6d are connected via associated circuitry and components to one or more digital processors inside the device 1. The transmitter 7 and receivers 6a-6d may, in addition to supporting ultrasonic signals, also be suitable for use for speech and other audio functions, thereby saving manufacturing costs and reducing the number of components visible on the surface of the device 1.

The transmitter 7 could, for example, be a Hibox HB18E speaker, manufactured by Hibox, Taiwan, which the Applicant has found to be successfully useable for both speech and ultrasound transmissions. Similarly the receivers 6a-6d could be microphones manufactured by Knowles Electronics, which have sufficient bandwidth for receiving both audible and ultrasonic signals. It will be appreciated that other embodiments may have more transmitters and more or fewer receivers, and these need not necessarily all be mounted in a plane, but some could be on an edge or the reverse face of the device 1.

To characterise the motion of the user's hand 4 or fingertip 5 (which may be to determine a precise coordinate in space, or which may be to identify a particular gesture from a set of possible gestures), in one embodiment a sequence of ultrasonic chirps is transmitted from transmitter 7 at a frame rate, with intervals of silence between each pair of chirps. Other types of transmit signal may of course be used, and the device 1 may be capable of switching between two or more different types of signal or coding scheme, depending, for example, on the mode of operation, or on the level of background noise. Different chirps or other suitable signals may be coded for different receivers 6a-6d.

The transmitted chirp propagates substantially hemispherically from the transmitter 7. One part of the wavefront hits the fingertip 5 of the user's input hand 4, from which it is reflected in many directions. A part of the reflected sound is received by each of the four receivers 6a-6d. Although FIG. 1 shows only a single sound path, it will be understood that sound strikes all parts of the fingertip 5 that are in direct view of the transmitter 7, and that each receiver receives sound from many parts of the fingertip 5 at slightly different moments.

The receivers 6a-6d also receive the transmitted signals along direct paths from the transmitter 7. Because these paths will necessarily be the shorter than even the shortest reflected paths off the user's hand 4, the direct-path signals will be received first at the receivers 6a-6d.

If, for any receiver 6a-6d, the transmitted chirp is of longer duration than the difference in path length between the nearest reflective point in the environment (e.g. on the user's hand 4) and the direct path, the signals received at that receiver will overlap.

FIG. 2 shows an exemplary plot of amplitude against time for a signal that might be received along the direct path between the transmitter 7 and the receiver 6a, when the transmitter 7 has transmitted a rising chirp.

FIG. 3 shows a plot of the reflection of the rising chirp, as received at the receiver 6a, having been reflected off the user's fingertip 5. The start of the chirp is received later than is the start of the chirp along the direct path. The signal is also of lower amplitude, due to attenuation of the sound through the air and when reflected off the acoustically-soft surface of the user's finger.

FIG. 4 shows a plot of the combination of direct-path and reflected signals, as might actually be received at the receiver 6a. A superposition of both signal components occurs during the period of overlap.

FIGS. 2, 3 and 4 also contain horizontal positive and negative Vmax lines, representing the maximum resolution of an AD converter within the device 1. The lines show the input amplitude to the converter beyond which the output of the converter is overloaded i.e. a constant 0xFF . . . FF.

While the direct-path signal and the reflected signals taken separately are each within the resolution of the AD converter, during the overlap period in FIG. 3 the received signal exceeds the Vmax limits.

If, as in prior-art arrangements, the signal received at the receiver 6a is passed to the AD converter, digital clipping will occur. Information is thus lost from the signal, and the linearity of the signal is also destroyed, making subsequent separation of the reflected signal of interest from the direct-path signal very difficult. While the level of amplification could be reduced so that clipping does not occur, this then reduces the dynamic range content of the signal of interest, i.e. the echoes from the input object, potentially resulting in reduced accuracy.

However, the present embodiment overcomes this problem.

FIG. 5 figuratively shows significant components of a handheld device 51, similar to that of FIG. 1. The device 51 has a central processing unit 52 which can output signals via a digital-to-analogue (DA) converter 53 to a loudspeaker 54.

Acoustic signals are received at a microphone 55. These may include reflections and direct-path energy from a signal transmitted by the loudspeaker 54 under the control of the CPU 52. Rather than passing directly to an AD converter, as in prior art arrangements, the received analogue signals are sent to a filter unit 56. This filter unit 56 can also receive control commands (which may be digital or analogue) from the CPU 52. The filter unit 56 outputs a filtered analogue signal to an AD converter 57, which digitises the signal and sends it to the CPU 52. The CPU 52 may also control other components of the device, such as communication modules, display screens, etc. (not shown).

The filter unit 56 may contain a number of band-pass filters, or other filters, and the CPU 52 can control which filter or filters are applied to signals received from the microphone 55.

By having the necessary filters within the filter unit 56, and by configuring the CPU 52 to apply these filters appropriately, operations can be performed relatively efficiently in the analogue domain which would otherwise have required relatively inefficient digital processing by the CPU 52, or other digital components such as a DSP (not shown).

For example, the filter unit 56 may comprise a plurality of sine and cosine filters (i.e. filters at 90 degrees to each other), for different frequency bands. Such an arrangement can be particularly advantageous when carrying out an approximate de-chirp operation, or when receive-pattern matching with an otherwise modulated signal.

If the filter unit 56 has two bandpass filters per frequency band, one with a phase-shift of 90 degrees relative to the other, both the received phase and amplitude at the corresponding frequency receive-band can be computed without the use of CPU-costly digital operations by the main processor. A full demodulation operation can be carried out by summing up the contributions for each frequency band.

For instance, the CPU 62 may instruct the filter unit 56 to provide information from a frequency band centred on frequency ω. The filter unit 56 may then output a sine-filtered signal to the AD converter 57 and a cosine-filtered signal to a second AD converter (not shown).

For a received signal s(t) evaluated within a time-window of length T, two filtered signals v₁ and v₂ may be generated as follows:

$${v}_{1} ( ϖ , t ) = {\int }_{τ = t - T}^{t} cos ( ϖτ ) s ( τ - \partial ( ϖ ) ) d τ$$

$${v}_{2} ( ϖ , t ) = {\int }_{τ = t - T}^{t} sin ( ϖτ ) s ( τ - \partial ( ϖ ) ) d τ$$

where ∂( ω̅) is a line delay factor applied to the signal, which may be specific to the particular frequency band, and to the required demodulation operation. The line delay factor could be applied to the input signal s(t), or to the output signal after filtering. Alternatively, the delay could be implemented in the digital domain post-sampling.

The integral might also contain a weighting of each point along the interval over which the integral is evaluated, such as a Hamming, Hann or Gaussian window, so as to reduce spectral leakage.

The integral could be evaluated by simply multiplying in the respective sine or cosine signal for the frequency and passing the product on to an integrator. Many electrical components, such as amplifiers, will naturally work as integrators; however, a dedicated circuit could be used.

A sinusoid filter with an arbitrary phase θ can be obtained by combining the signals v₁ and v₂. In particular,

$${\int }_{τ = t - T}^{t} cos ( ϖτ + θ ) s ( τ - \partial ( ϖ ) ) d τ = {av}_{1} ( ϖ , t ) + {bv}_{2} ( ϖ , t ) ,$$

for appropriately chosen constants a and b.

Alternatively, at the expense of some flexibility, the following signal could be formed directly without first constructing v₁ and v₂:

$$v ( ϖ , t ) = {\int }_{τ = t - T}^{t} cos ( ϖτ + θ ) s ( τ - \partial ( ϖ ) ) d τ$$

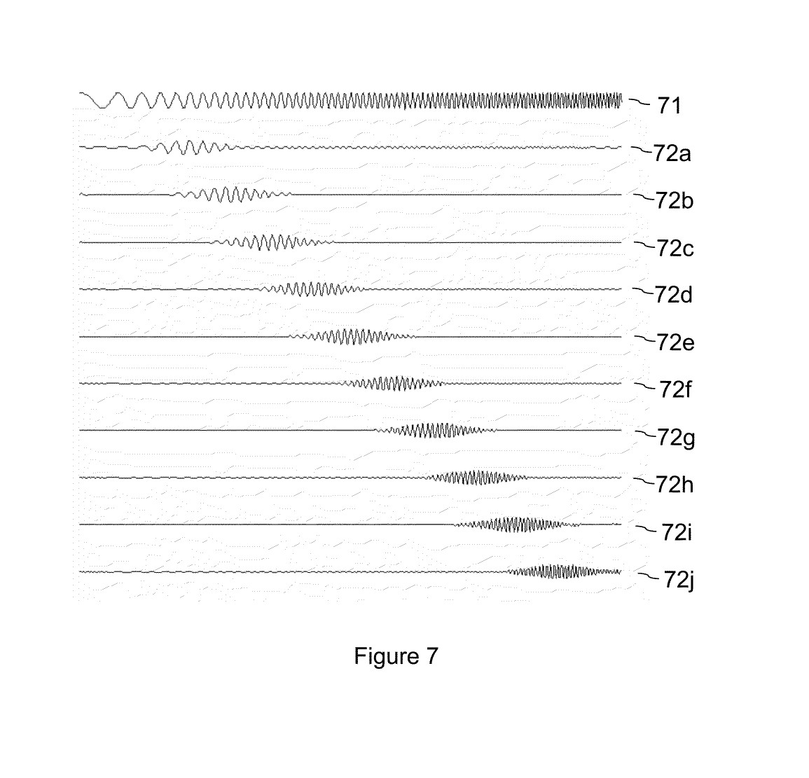

By having a plurality of filter pairs in the filter unit 56, each pair operating at a different frequency band ω̅ᵢ and with a relative signal delay ∂( ω̅ᵢ) applied to each pair, it will be seen that a sum of such filters can be made to function as a chirp filter. This stems from the observation that a chirp signal can, at least approximately, be decomposed into a set of suitably delayed and phased sinusoids with a local envelope, as shown in FIG. 7.

FIG. 7 shows the amplitude (vertical axis) of a linear chirp 71, which rises in frequency over time (horizontal axis). The outputs 72a-72j of a set of partially-overlapping, relatively-narrow band-pass filters to this chirp signal 71 are shown below the chirp 71, with horizontally-aligned time axes. The individual temporal offsets can clearly be seen. When applied as a set of respective line delay factors ∂( ω̅) in the filter unit 56 or the CPU 52, a chirp signal that matches signal 71 will be registered by the CPU 52, while other signals will be filtered out.

FIG. 6 shows one particular embodiment of a device 61 which can be used to address the problem illustrated in graph of FIG. 4. Components labelled 6x are the same as those labelled 5x in FIG. 5. Additionally, FIG. 6 has a second DA converter 68, not present in FIG. 5. This converts digital output signals from the CPU 62 into a second analogue input to the filter unit 66.

The filter unit 66 comprises an additive mixer, which, in combination with a signal inversion step carried out in the CPU 62 or in the filter unit 66 itself, causes a digital signal synthesised in the CPU 62 to be subtracted from an analogue signal derived from the microphone 65. The CPU 62 can be configured to synthesise a signal which is an estimate of the direct-path energy received at the microphone 65 from the loudspeaker 64 (see the graph in FIG. 2). This signal may be synthesised using one or more of: a previously-received received signal, such as one including a direct-path signal; a plurality of such signals; knowledge of a transmitted signal; information relating to the structure or acoustic characteristics of the device 61; and information relating to the environment, such as air temperature or humidity.

As will be appreciated by the skilled person, the filter unit 66 and/or CPU 62 may comprise a feedback control or regulator in order to synchronise appropriately the subtraction of the synthesised signal from the primary analogue input to the filter unit 66.

When correctly configured, the received signal of FIG. 4 can be sent to the filter unit 66, in which the direct-path component of FIG. 2 is subtracted, leaving substantially only the reflected-path components of FIG. 3 to be output from the filter unit 66 to the CPU 62, via the AD converter 67.

The CPU 62 can then process the reflected-path components to identify a user input, without having to attempt to remove a direct-path contribution. Moreover, the risk of clipping in the AD converter 67 is lessened, which could otherwise lead to errors in input recognition.

The CPU 62 may recognise a user input and cause the device 61 to perform a function, such as changing content on the display screen 2, in response to the input.

Although these embodiments have been of a handheld device, the invention is not limited to such devices, and could equally be applied to static appliances such as a television set, washing machine, personal computer, etc. A display screen is not necessary, although one may advantageously be provided to enhance user interaction with the device by providing visual feedback.

1. Electronic apparatus comprising:
a transmitter arranged to transmit an ultrasonic signal;
a receiver arranged to receive a reflection of the ultrasonic signal from an input object, and to generate a received analogue electrical signal therefrom;
a filter arranged to take the received analogue electrical signal as input and to output a filtered analogue electrical signal; and
a digital processor configured to control a characteristic of the filter, and to use the filtered analogue electrical signal to determine a user input to the electronic apparatus.

2. Apparatus as claimed in claim 1 comprising a portable device.

3. Apparatus as claimed in claim 1 wherein the filter comprises one or more digital components.

4. Apparatus as claimed in claim 1 wherein the processor is arranged to determine how to control the filter based on an analysis of signals the processing means is currently receiving, or has previously received.

5. Apparatus as claimed in claim 1 wherein the characteristic of the filter controlled by the processor is whether the filter is enabled or not.

6. Apparatus as claimed in claim 1 wherein the filter has two or more modes of operation, with the processor able to select one or more of these modes.

7. Apparatus as claimed in claim 6 wherein the filter selectively either passes audible sound while removing ultrasound, or passes ultrasound while removing audible sound and arranged such that the processor can switch the filter between these two modes depending on whether the device is attempting to receive audible input or ultrasonic input.

8. Apparatus as claimed in claim 1 wherein the characteristic of the filter controlled by the processor comprises which frequency band or bands are to be filtered or passed.

9. Apparatus as claimed in claim 8 wherein the bands together span a continuous frequency range.

10. Apparatus as claimed in claim 8 comprising a multi-band filter controlled by the processor so as to remove signals outside a band encompassing the reflected signals from the input object, when receiving a user input.

11. Apparatus as claimed in claim 1 wherein the filter comprises a variable bandpass filter, with the digital processing means being configured to control the variable filter so as to output a succession of analogue electrical signals that have been filtered using different respective bandpass ranges.

12. Apparatus as claimed in claim 1 wherein the filter comprises a plurality of bandpass filters collectively arranged to output a plurality of analogue electrical signals simultaneously.

13. Apparatus as claimed in claim 1 wherein the filter is arranged to provide phase information relating to the filtered analogue electrical signal.

14. Apparatus as claimed in claim 13 wherein the filter comprises a sine filter and a cosine filter for each of a plurality of frequency ranges.

15. Apparatus as claimed in claim 1 wherein the filter comprises a plurality of sub-filters which are selectively couplable to an AD converter.

16. Apparatus as claimed in claim 1 wherein the filter comprises a plurality of sub-filters and comprising a plurality of AD converters, with each sub-filter being coupled to a corresponding AD converter.

17. Apparatus as claimed in claim 1 wherein the transmit signal comprises a chirp.

18. Apparatus as claimed in claim 1 wherein the processor is configured to cause the device to transmit different chirps depending on circumstances, and further wherein the processor is configured to control the filter so as to apply a de-chirp operation for a previously-transmitted chirp signal.

19. Electronic apparatus comprising:
a transmitter arranged to transmit an encoded ultrasonic signal;
a receiver arranged to receive a reflection of the ultrasonic signal from an input object, and to generate a received analogue electrical signal therefrom;
a filter arranged to take the received analogue electrical signal as input and to output a filtered analogue electrical signal, wherein said filter is adapted so as at least partially to apply pulse-compression to said analog electrical signal; and
a digital processor configured to use the filtered analogue electrical signal to determine a user input to the electronic apparatus.

20. Apparatus as claimed in claim 19 wherein the filter is arranged to remove from the received signal a contribution arising from energy in the transmit signal that has travelled along a direct path from the transmitter to the receiver.

21. Apparatus as claimed in claim 20 wherein the digital processor is configured to provide to the filter an estimate of the contribution to the received signal arising from signals which travel along the direct path and wherein the filter is arranged to use said estimate when filtering the received signal.

22. Apparatus as claimed in claim 21 arranged to sign-reverse said estimate, pass said estimate through an DA converter, and superimposes the reversed, analogue estimate on the received analogue signal.

23. Apparatus as claimed in claim 20 comprising a feedback arrangement configured to refine the estimate of the direct-path contribution and/or to synchronise the superimposing operation so as to provide effective subtraction.

24. Electronic apparatus comprising:
a transmitter arranged to transmit an ultrasonic signal;
a receiver which receives i) a direct path signal from the transmitting means; and ii) a reflection of the ultrasonic signal from an input object, and to generate a received analogue electrical signal therefrom;
a filter arranged to take the received analogue electrical signal as input and to output a filtered analogue electrical signal, wherein said filter is adapted to reduce a contribution of the direct path signal in the analogue electrical signal relative to a contribution of the reflected signal; and
a digital processor configured to use the filtered analogue electrical signal to determine a user input to the electronic apparatus.

25. Apparatus as claimed in claim 24 wherein the transmitter comprises one or more transmitters capable of generating ultrasound and the receiver comprises one or more receivers capable of receiving ultrasound.

26. A method of determining a user input to an electronic apparatus comprising:
transmitting an ultrasonic signal;
receiving a reflection of the ultrasonic signal from an input object;
generating a received analogue electrical signal from the reflection;
filtering the received analogue electrical signal in a filter which outputs a filtered analogue electrical signal; and
controlling a characteristic of the filter with a digital processing means; and
using the digital processing means to determine a user input to the electronic apparatus from the filtered analogue electrical signal.
